(19) United States
(12) Patent Application Publication
(10) Pub. No.: US 2008/0233437 A1
(43) Pub. Date: Sep. 25, 2008

(54) Fuel Cell System and Control Method Therefor

(75) Inventors: Yasuyuki Muramatsu, Shizuoka (JP); Masatsugu Oishi, Shizuoka (JP)

Correspondence Address: YAMAHA HATSUDOKI KABUSHIKI KAISHA;C/O KEATING & BENNETT, LLP, 1800 Alexander Bell Drive, SUITE 200, Reston, VA, 20191, US

(73) Assignee: YAMAHA HATSUDOKI KABUSHIKI KAISHA, Iwata-shi, Shizuoka-ken (JP)

(21) Appl. No.: 10/599,469

(22) PCT Filed: Mar. 28, 2005
(86) PCT No.: PCT/JP05/06546

§ 371 Date: Jun. 5, 2008

(30) Foreign Application Priority Data
Apr. 1, 2004 (JP) 2004-109018
Jun. 15, 2004 (JP) 2004-177649

(51) Int. Cl. H01M 8/04

(52) U.S. Cl. 429/13; 429/12; 429/34; 429/24; 429/22

(57) ABSTRACT

A fuel cell system preferably includes a fuel cell which generates electric energy by electrochemical reaction, an aqueous solution tank which holds the methanol aqueous solution, a water tank which holds fluid discharged from the fuel cell, a fluid level sensor for detecting an amount of fluid in the water tank, a water pump which recycles fluid in the water tank to the aqueous solution tank, and a CPU which controls components of the fuel cell system. After power generation is finished, the water pump is driven to recycle all the fluid in the water tank to the aqueous solution tank. Further, after power generation is finished or before power generation is started, the fluid level sensor detects the amount of fluid in the water tank. If the amount of fluid is not smaller than a predetermined amount, the water pump is driven to recycle fluid in the water tank to the aqueous solution tank. The fuel cell system has a simple construction and is capable of preventing fluid from being discharged outside.

### BACKGROUND OF THE INVENTION

1. Field of the Invention

The present invention relates to a fuel cell system and a control method therefor, and more specifically, to a fuel cell system which collects fluid discharged from the fuel cell and a control method therefor.

2. Description of the Related Art

In this type of fuel cell system, generally, water that is produced in a reaction in the fuel cell is collected in a water tank, and water in the water tank is recycled to an aqueous solution tank. In the aqueous solution tank, the recycled water is mixed with highly concentrated methanol fuel, to become methanol aqueous solution which is necessary for power generation.

If such a fuel cell system is provided in a vehicle, and if the water tank freezes when the vehicle is left outdoors in winter or cold weather, the fuel cell system cannot recycle water, resulting in a problem that concentration adjustment of the methanol aqueous solution becomes impossible.

An example of techniques for preventing such a problem is disclosed in JP-A 2000-21430, hereinafter referred to as Patent Document 1.

According to Patent Document 1, when the fuel cell system ceases operation, water in the water tank is moved to the aqueous solution tank as necessary, to cause the aqueous solution tank to be full. Thereafter, a switching valve connected with a bottom of the water tank via a drain channel is opened to discharge water from the water tank and from water channels.

However, the technique disclosed in Patent Document 1 requires a drain channel and a switching valve, which complicates the fuel cell system.

Further, when a fuel cell system which incorporates this technique is used in a vehicle, for example, and if the vehicle is parked indoors such as in a garage, the water discharge undesirably occurs indoors.

Further, according to the technique disclosed in Patent Document 1, unnecessary water is discharged and thus the water tank becomes empty after power generation is finished. But thereafter, water remaining in the fuel cell oozes out of the fuel cell and gathers in the water tank. The water tank tends to collect more water if the system is designed such that the fuel cell is supplied with water after power generation has stopped in order to prevent the electrolyte from drying up. In this case, after power generation is finished, water oozes out of the fuel cell due to crossover and enters the water tank.

Currently, a conventional fuel cell system exists in which an air pump is used to supply air to the fuel cell, and resulting exhaust gas which is discharged from the fuel cell is introduced to the water tank, together with water. In this fuel cell system, water is held in the water tank, and the exhaust gas is discharged from the water tank via a discharge port provided therein. This fuel cell system will have a problem if it uses the technique described in Patent Document 1 which tends to collect water in the water tank after power generation is finished.

Specifically, in this fuel cell system, if water accumulates in the water tank after power generation is finished, the water can be blown out of the discharge port when power generation is started next time, as operation of the air pump creates a whirling blast of exhaust gas in the water tank.

### SUMMARY OF THE INVENTION

In order to overcome the problems described above, preferred embodiments of the present invention provide a fuel cell system which has a simple construction and is capable of preventing fluid from being discharged outside, and a control method therefor.

A preferred embodiment of the present invention provides a fuel cell system which includes a fuel cell which generates electric energy by electrochemical reaction, a first tank which holds fluid discharged from the fuel cell, a second tank to which fluid in the first tank is introduced, a first drive element arranged to move the fluid in the first tank to the second tank, and a controller arranged to control operation of the first drive element at a time of non-power-generation.

Another preferred embodiment of the present invention provides a control method for a fuel cell system which includes a fuel cell which generates electric energy by electrochemical reaction, a first tank which holds fluid discharged from the fuel cell and a second tank to which fluid in the first tank is introduced. According to the control method, fluid in the first tank is moved to the second tank at a time of non-power-generation.

Preferred embodiments of the present invention prevent fluid from being discharged outside, while having a simple construction.

Preferably, the second tank is an aqueous solution tank which holds fuel aqueous solution to be supplied to the fuel cell. After power generation is finished, all the fluid in the first tank is recycled to the aqueous solution tank and mixed with fuel aqueous solution in the aqueous solution tank. This empties the first tank, preventing the first tank from freezing and making it possible to adequately adjust the concentration of fuel aqueous solution. As a result, it is possible to operate the fuel cell system appropriately. Further, since all the fluid in the first tank is recycled to the aqueous solution tank, there is no probability that the fluid leaks outside. Since the aqueous solution in the aqueous solution tank is alcohol aqueous solution, it has a lower freezing point than water, and thus, does not freeze as easily as water.

Further, preferably, the fuel cell system further includes a first channel which connects the first tank with the aqueous solution tank. After power generation is finished, all the fluid in the first tank is recycled to the aqueous solution tank via the first channel. This virtually empties the first tank and the first channel, thus preventing the first tank and the first channel from freezing. The first channel between the first tank and the aqueous solution tank can preferably be provided by an existing water recycling pipe, so that the system does not become complicated.

Further preferably, the fuel cell system further includes a second drive element arranged to move fluid in the fuel cell to the first tank. After power generation is finished, the controller controls operation of the second drive device to move the fluid in the fuel cell to the aqueous solution tank via the first tank. In this case, fluid in the fuel cell is also recycled to the aqueous solution tank, thereby preventing freezing in the fuel cell and the water tank. This also facilitates gas exhaust and fluid collection from the fuel cell.

Preferably, the fuel cell system further includes a second channel which connects the fuel cell with the first tank. After power generation is finished, fluid in the fuel cell and the second channel is moved to the aqueous solution tank via the first tank and the first channel. In this case, fluid in the second channel is also recycled into the aqueous solution tank, making the portion between the fuel cell and the first tank also free from freezing.

Further, preferably, after power generation is finished, the controller controls operation of the first drive device and the second drive device based on temperature information of the fuel cell system, and moves the fluid to the aqueous solution tank.

In fuel cell systems which utilize a fuel aqueous solution, there is a problem of water crossover from an anode side to a cathode side. Especially in direct methanol fuel cell systems, since power generation is made by supplying the anode with methanol aqueous solution, water remains around the anode after the power generation, and gradually moves toward the cathode side and to the channel on the cathode side even if the channel is emptied at the end of the power generation. Although the amount of water is small, it is enough to close the fuel cell exit. Another potential problem is freezing of water which has been liquefied from saturated aqueous vapor in the second channel due to a temperature decrease after power generation is finished. In order to deal with this, fluid is recycled to the aqueous solution tank each time when freezing is forecast based on the temperature information of the fuel cell system. This enables the fuel cell system to effectively prevent the problem from freezing. Further, fluid is recycled to the aqueous solution tank not regularly but when freezing is possible, after power generation is finished. Thus, it becomes possible to reduce power consumption that is necessary to recycle the fluid.

Further preferably, after power generation is finished, the controller operates the first drive device and the second drive device again in a predetermined amount of time after operating the first drive device and the second drive device. As described above, fluid is recycled to the aqueous solution tank once, and after a predetermined amount of time, recycling of fluid is performed again to the aqueous solution tank. This effectively prevents freezing even in the event of the above-described water crossover from the anode side to the cathode side or the liquefaction of water vapor in the second channel.

Preferably, the aqueous solution tank has a volume V which satisfies:

$$V ≧ v 1 + ( v 2 + v 3 + v 4 + v 5 ) \times ( 1 + \frac{p 2}{p 1 - p 2} )$$

where V represents the volume of the aqueous solution tank; v1 represents the volume of methanol aqueous solution in the aqueous solution tank during power generation; v2 represents the volume of fluid storable by the first tank; v3 represents the volume of fluid which can remain in the first channel; v4 represents the volume of fluid which can remain in the second channel; v5 represents the volume of fluid which can remain in the fuel cell; p1 represents a concentration of fuel; and p2 represents a maximum concentration of methanol aqueous solution.

In this case, even if all the fluid in the first tank, the fuel cell, the first channel and the second channel is recycled to the aqueous solution tank, fuel aqueous solution does not overflow from the aqueous solution tank. Further, fuel aqueous solution does not overflow from the aqueous solution tank, either, at the next system startup, when fuel is added to the aqueous solution tank in order to obtain fuel aqueous solution of a desired concentration, and so there will be no external leak of the fuel aqueous solution.

Further, preferably, the fuel cell system further includes an air pump for supplying the fuel cell with air necessary for the generation of electric energy and a sensor for detecting an amount of fluid in the first tank. The first tank includes an exhaust port, the first drive device is preferably a water pump, and the controller controls operation of the water pump based on the amount of fluid in the first tank detected by the sensor, at the time of non-power-generation. With this arrangement, if the amount of fluid in the first tank detected at the time of non-power-generation is greater than a predetermined amount, an amount of fluid in the first tank which would be discharged from the exhaust port by exhaust gas associating with the operation of air pump is moved to the second tank. Therefore, it becomes possible to restrict discharge of fluid from the exhaust port when the power generation is started, and to reuse the discharged fluid from the fuel cell effectively, without wasting.

Further preferably, before starting power generation, the controller controls operation of the water pump before driving the air pump. With this arrangement, if the amount of fluid in the first tank detected before starting the power generation is greater than a predetermined amount, an amount of fluid in the first tank which would be discharged from the exhaust port by exhaust gas associating with the operation of air pump is moved to the second tank before the air pump is driven. Therefore, it becomes possible to restrict discharge of fluid from the exhaust port when the power generation is started, and to reuse the discharged fluid from the fuel cell effectively, without wasting.

Preferably, after power generation is finished, the controller controls operation of the water pump. With this arrangement, if the amount of fluid in the first tank detected after power generation is finished is greater than a predetermined amount, an amount of fluid in the first tank which would be discharged from the exhaust port by exhaust gas associated with the operation of air pump at the beginning of next power generation is moved to the second tank. Therefore, it becomes possible to restrict discharge of fluid from the exhaust port when the power generation is started next time, and to reuse the discharged fluid from the fuel cell effectively, without wasting.

By performing this process not only after power generation is finished but also before power generation is started, it becomes possible to restrict discharge of fluid from the exhaust port which was discharged from the fuel cell before power generation is finished, as well as fluid which oozes from the fuel cell after power generation is finished and the process is performed, making it possible to reuse fluid discharged from the fuel cell more reliably and efficiently.

Further, preferably, after power generation is finished, the controller controls the operation of the water pump based on the amount of fluid in the first tank detected by a sensor, at a predetermined time interval. With this arrangement, fluid in the first tank is moved to the second tank each time that the amount of fluid in the first tank detected at a predetermined time interval after power generation is greater than a predetermined amount. In other words, adjustment is made at a predetermined time interval after power generation is finished, so that the amount of fluid in the first tank will not exceed a predetermined amount. Therefore, fluid which oozes from the fuel cell after power generation is prevented from reaching the exhaust port of the first tank where it would be discharged, and the fluid which oozes from the fuel cell after power generation is reused certainly.

Further preferably, the second tank is provided by an aqueous solution tank which holds fuel aqueous solution to be supplied to the fuel cell. In this case, there is no need for providing the second tank separately, and fluid discharged from the fuel cell is reused effectively without being wasted and without increasing the size of the system.

According to various preferred embodiments of the present invention, fluid which oozes from the fuel cell after power generation is also reused effectively without being wasted. Therefore, even if the fuel cell system has such a construction that the fuel cell is placed lower than the aqueous solution tank and the fuel cell is continued to be supplied with fuel aqueous solution after power generation, there is no decrease in fuel utilization efficiency.

In order to improve portability of the direct methanol fuel cell system, material supply for power generation must be achieved as much as possible within the system without depending upon external supply. Preferred embodiments of the present invention enable the fuel cell system to effectively reuse discharged fluid from the fuel cell without being wasted. Application of preferred embodiments of the present invention to direct methanol fuel cell systems improves portability of the systems.

The fuel cell system described above is applicable suitably to transport equipment.

Other features, elements, steps, characteristics and advantages will become more apparent from the following detailed description of preferred embodiments of the present invention with respect to the attached drawings.

### BRIEF DESCRIPTION OF THE DRAWINGS

FIG. 1 is a schematic drawing which shows a primary portion of a fuel cell system according to a preferred embodiment of the present invention.

FIG. 2 is a perspective view which shows the fuel cell system according to a preferred embodiment of the present invention mounted on a frame of a motorcycle.

FIG. 3 is a schematic drawing which shows a primary portion of the fuel cell system according to a preferred embodiment of the present invention.

FIG. 4 is a block diagram which shows an electrical construction of the fuel cell system according to a preferred embodiment of the present invention.

FIG. 5 is a front view which shows a water tank and its surrounding elements.

FIG. 6 is a side view which shows a water tank and its surrounding elements.

FIG. 7 is a flowchart which shows an example of an operation according to a preferred embodiment of the present invention.

FIG. 8 is a flowchart which shows an example of freeze prevention operation achieved by a preferred embodiment of the present invention.

FIG. 9 is a flowchart which shows an example of operation according to a preferred embodiment of the present invention.

FIG. 10 is a flowchart which shows another example of operation according to a preferred embodiment of the present invention.

FIG. 11 is a flowchart which shows a continued portion of the operation in FIG. 10.

### DETAILED DESCRIPTION OF PREFERRED EMBODIMENTS

Hereinafter, preferred embodiments of the present invention will be described with reference to the drawings.

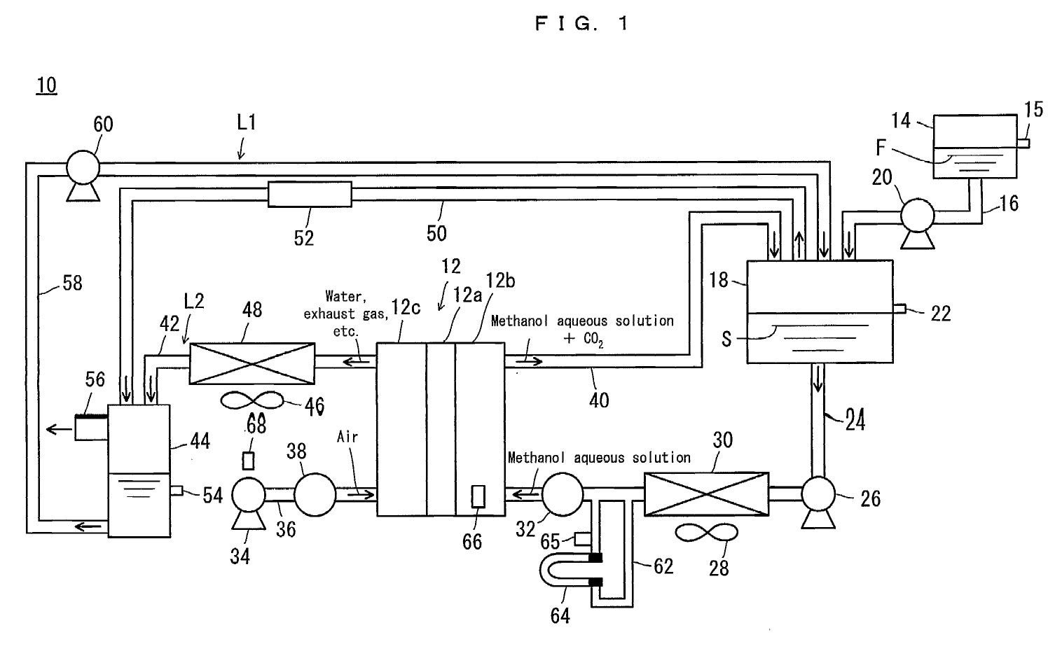

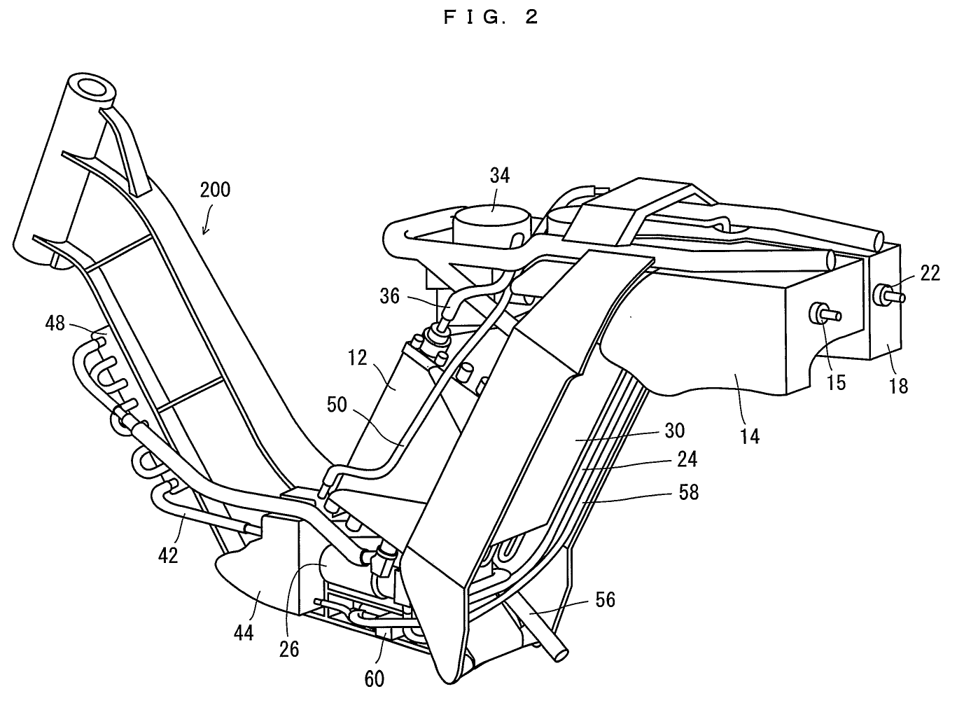

As shown in FIG. 1 through FIG. 4, a fuel cell system 10 according to a preferred embodiment of the present invention is provided as a direct methanol fuel cell system. Direct methanol fuel cell systems do not require a reformer, and therefore are used suitably in equipment in which portability is essential and/or smallness in size is desired. Here, description will be made for a case in which the fuel cell system 10 is used in a motorcycle as an example of transport equipment but the present invention is in no way limited to this example. As shown in FIG. 2, the motorcycle will be represented only by a vehicle frame 200. The fuel cell system 10 is disposed along the vehicle frame 200.

Referring mainly to FIG. 1, the fuel cell system 10 includes a fuel cell 12. The fuel cell 12 preferably includes a fuel cell stack or a plurality of direct methanol fuel cells connected (laminated) in series, each of which includes an electrolyte provided by a solid polymer film 12a, and an anode (fuel electrode) 12b and a cathode (air electrode) 12c which sandwich the solid polymer film 12a.

The fuel cell system 10 includes a fuel tank 14 which holds fuel, which is preferably highly concentrated methanol fuel (e.g., an aqueous solution containing approximately 50 wt % of methanol) F. The fuel tank 14 is connected, via a fuel supply pipe 16, with an aqueous solution tank 18 which stores fuel aqueous solution that is preferably the methanol aqueous solution S. The fuel supply pipe 16 is provided with a fuel pump 20. The fuel pump 20 supplies the aqueous solution tank 18 with the methanol fuel F from the fuel tank 14. The fuel tank 14 is provided with a fluid level sensor 15 for detecting the level (the height of fluid surface) of methanol fuel F in the fuel tank 14. The aqueous solution tank 18 is provided with a fluid level sensor 22 for detecting the level of the methanol aqueous solution S in the aqueous solution tank 18.

The aqueous solution tank 18 is connected, via an aqueous solution pipe 24, with the anode 12b of the fuel cell stack 12. The aqueous solution pipe 24 is provided with an aqueous solution pump 26, a heat exchanger 30 equipped with a cooling fan 28, and an aqueous solution filter 32, respectively from the upstream side. The methanol aqueous solution S in the aqueous solution tank 18 is pumped by the aqueous solution pump 26 toward the anode 12b, cooled by the heat exchanger 30 as necessary, and then purified by the aqueous solution filter 32 before supplied to the anode 12b.

On the other hand, the cathode 12c in the fuel cell 12 is connected with an air pump 34 via an air pipe 36. The air pipe 36 is provided with an air filter 38. Thus, air which contains oxygen is sent from the air pump 34, purified by the air filter 38 and then supplied to the cathode 12c.

The anode 12b and the aqueous solution tank 18 are connected with each other via a pipe 40, so unused methanol aqueous solution S and produced carbon dioxide discharged from the anode 12b are supplied to the aqueous solution tank 18.

Further, the cathode 12c is connected with the water tank 44 via a pipe 42. The pipe 42 is provided with a gas-liquid separator 48 equipped with a cooling fan 46. When the air pump 34 is operated, fluid which contains water is discharged from the cathode 12c, together with exhaust gas, etc., to the water tank 44 via a pipe 42.

The aqueous solution tank 18 and the water tank 44 are connected with each other via the CO₂ vent pipe 50. The CO₂ vent pipe 50 is provided with a methanol trap 52 which separates the methanol aqueous solution S. The carbon dioxide discharged from the aqueous solution tank 18 is thus supplied to the water tank 44.

The water tank 44 is provided with a fluid level sensor 54, which detects the level of water in the water tank 44. The water tank 44 is provided with an exhaust gas pipe 56. The exhaust gas pipe 56 discharges carbon dioxide and the exhaust gas from the cathode 12c.

The water tank 44 is connected with the aqueous solution tank 18 via the water recycling pipe 58. The water recycling pipe 58 is provided with a water pump 60. Fluid in the water tank 44 is recycled appropriately by the water pump 60 to the aqueous solution tank 18. In the present preferred embodiment, the water tank 44 defines the first tank whereas the aqueous solution tank 18 defines as the second tank. Also, the water pump 60 serves as the first drive device whereas the air pump 34 defines as the second drive device.

In this preferred embodiment, fluid which is discharged from the cathode 12c of the fuel cell 12, fluid which flows through a second channel L2 and is stored in the water tank 44, and fluid which flows through a first channel L1 and is supplied to the aqueous solution tank 18 are primarily water, but they may contain a small amount of methanol. However, when these fluids contain methanol, the methanol concentration is much smaller than that of the methanol aqueous solution S.

The water pump 60 is preferably defined by a diaphragm pump in order to provide reliable recycling of the fluid even when the volume of the fluid in the water tank 44 and water recycling pipe 58 becomes small. The water recycling pipe 58 is preferably made of a material which is not susceptible to pressure deformation.

The position where the water recycling pipe 58 is attached to the aqueous solution tank 18 is higher than the fluid level of the methanol aqueous solution S in the aqueous solution tank 18. The reason for this is if the water recycling pipe 58 is below the fluid level in the aqueous solution tank 18, the methanol aqueous solution S can flow back. The water recycling pipe 58 may be provided with a check valve.

The water recycling pipe 58 and the water pump 60 provide the first channel L1 whereas the pipe 42 and the gas-liquid separator 48 provide the second channel L2.

In the aqueous solution pipe 24, a bypass pipe 62 is disposed between the heat exchanger 30 and the aqueous solution filter 32. The bypass pipe 62 is provided with a concentration sensor 64 for detecting the concentration of the methanol aqueous solution S and an aqueous solution temperature sensor 65 for detecting the temperature of the methanol aqueous solution S. A cell temperature sensor 66 for detecting the temperature of the fuel cell 12 is attached to the fuel cell 12 whereas an ambient temperature sensor 68 for detecting the ambient temperature is provided near the air pump 34.

The concentration sensor 64 is preferably defined by, e.g., a supersonic sensor for measurement of variation in sonic speed caused by concentration change in methanol. In this case, the aqueous solution is placed between a pair of an ultrasonic transmitter and an ultrasonic receiver. The supersonic wave travels at different speeds depending on the concentration of the aqueous solution, so the methanol concentration of the aqueous solution can be measured based on this principle. The transmitter may be a Model PKH3-512B1S (manufactured by Murata Manufacturing Co., Ltd.) and the receiver may be provided by a Model PKH3-512B1R (manufactured by Murata Manufacturing Co., Ltd.). Alternatively, the concentration of the methanol aqueous solution S may be measured by using the weight, refractive index, viscosity, optical refractive index or electric resistance, of the methanol.

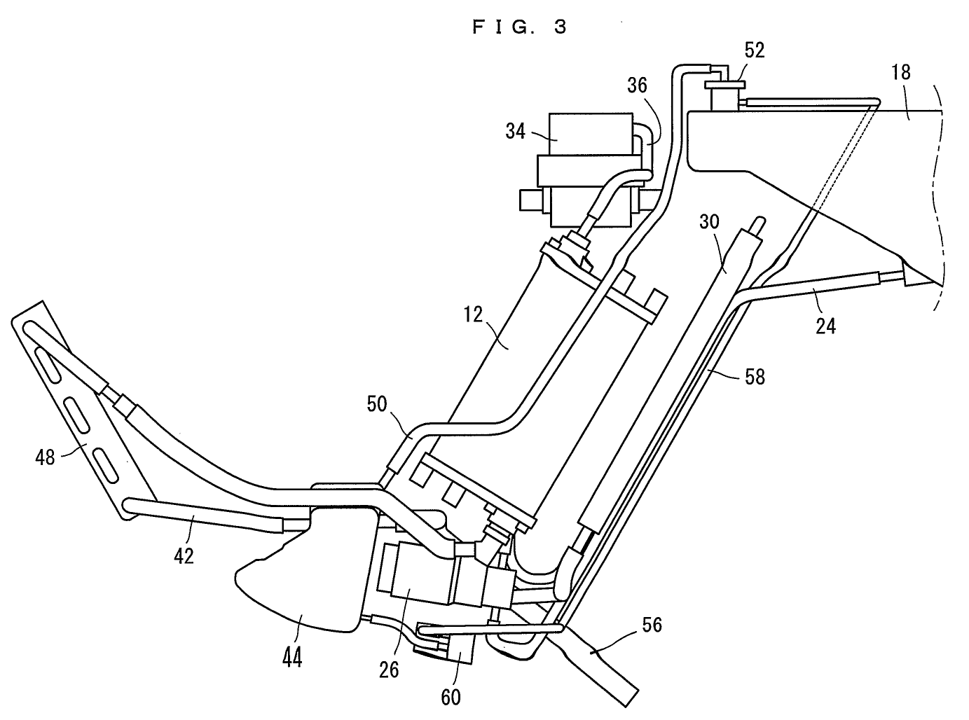

As understood from FIG. 2 and FIG. 3, in the fuel cell system 10, the fuel cell 12 is placed lower than the aqueous solution tank 18 so that the methanol aqueous solution S will flow gravitationally from the aqueous solution tank 18 even after power generation is finished. After power generation is finished, the aqueous solution pump 26 is no longer operating, yet it is not possible to perfectly block the methanol aqueous solution S which flows down from the aqueous solution tank 18 with the aqueous solution pump 26. The methanol aqueous solution S which flows down from the aqueous solution tank 18 passes through the aqueous solution pump 26, fills the aqueous solution pipe 24, and is supplied to the anode 12b. The methanol aqueous solution S which fills the anode 12b and the pipe 40 goes through the pipe 40 and back to the aqueous solution tank 18.

As described above, even after power generation is finished, the anode 12b is supplied with the methanol aqueous solution S, and the solid polymer film 12a is thereby kept wet, and ionic conductivity in the solid polymer film 12a is prevented from deteriorating during the time when there is no power generation. Further, by keeping the solid polymer film 12a wet, deterioration of the solid polymer film 12a such as cracking due to dryness is prevented. A portion of the methanol aqueous solution S supplied to the anode 12b after power generation is discharged from the cathode 12c due to crossover from the solid polymer film 12a, and stored in the water tank 44.

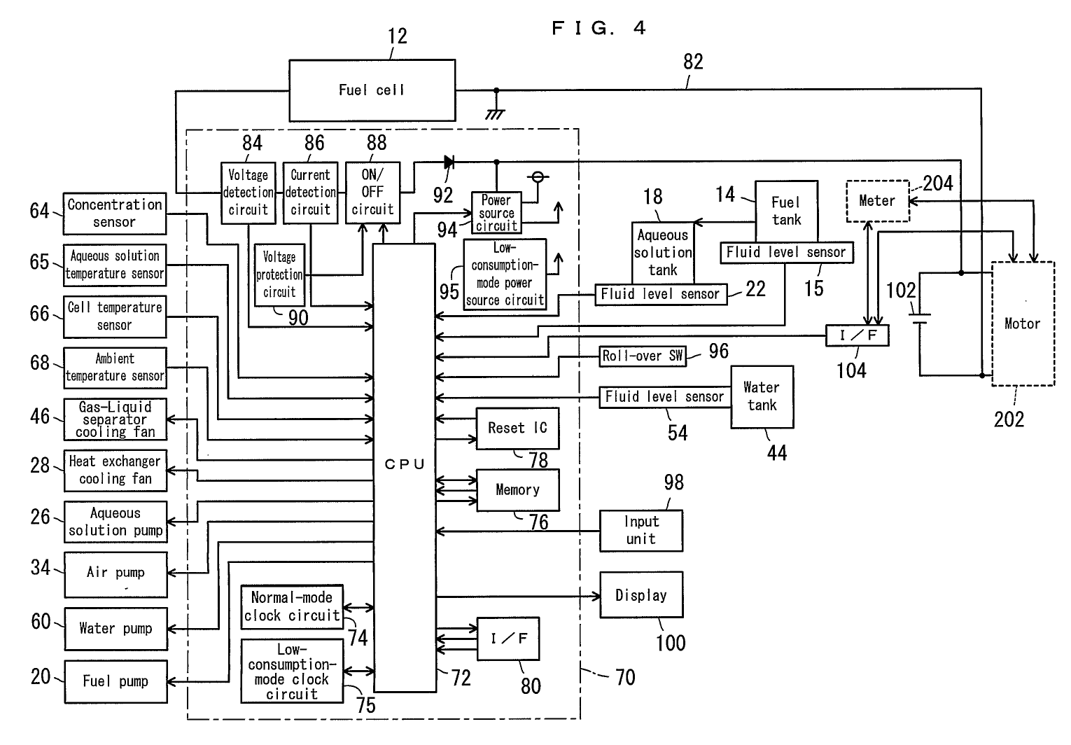

As shown in FIG. 4, the fuel cell system 10 includes a control circuit 70.

The control circuit 70 preferably includes: a CPU 72 which performs necessary calculations and controls operations of the fuel cell system 10, a normal-mode clock circuit 74 which supplies a normal-mode clock to the CPU 72, a low-consumption-mode clock circuit 75 which supplies the CPU 72 with a low-consumption-mode clock that is slower than the normal-mode clock; a memory 76 preferably defined by, e.g., an EEPROM which stores programs, data and calculation data, etc., necessary for controlling the fuel cell system 10; a reset IC 78 which prevents malfunction of the fuel cell system 10, an interface circuit 80 for connections with external devices; a voltage detection circuit 84 which detects voltages in an electric circuit 82 to which the fuel cell 12 is connected to power a motor 202 to drive the motorcycle or vehicle; an electric current detection circuit 86 which detects electric currents flowing in the electric circuit 82, an ON/OFF circuit 88 which opens and closes the electric circuit 82; a voltage protection circuit 90 which prevents an over voltage condition in the electric circuit 82; a diode 92 provided in the electric circuit 82; a power source circuit 94 which supplies a normal-mode voltage to the electric circuit 82, and a power source circuit 95 which supplies a low-consumption-mode voltage to the electric circuit 82.

In the control circuit 70 as described above, the CPU 72 is inputted with detection signals from the fluid level sensors 15, 22 and 54, as well as detection signals from the concentration sensor 64, the aqueous solution temperature sensor 65, the cell temperature sensor 66 and the ambient temperature sensor 68. Further, the CPU 72 is inputted with detection signals from a roll-over switch 96 which detects whether or not the vehicle has rolled over. Further, the CPU 72 is supplied with other signals for making various settings and information entry, from an input unit 98. The input unit 98 includes an unillustrated main switch. With an ON/OFF operation on the main switch, a signal which triggers a start-up or stop of power generation is supplied to the CPU 72.

The CPU 72 controls various components, such as the fuel pump 20, the aqueous solution pump 26, the air pump 34, the heat-exchanger cooling fan 28, the gas-liquid separator cooling fan 46 and the water pump 60. The CPU 72 also controls a display 100 which displays various information to an operator or rider of the vehicle or motorcycle.

The fuel cell 12 has a parallel connection with a secondary battery 102. The secondary battery 102 also has a parallel connection with the motor 202. The secondary battery 102 supplements the output from the fuel cell 12, is charged with electric energy from the fuel cell 12, and discharges to supply the motor 202 and other components with electric energy.

The motor 202 is connected with a meter 204 which makes measurements for various data relating to the motor 202. These data and status information about the motor 202 measured by the meter 204 are supplied to the CPU 72 via the interface circuit 104.

In the present preferred embodiment, the CPU 72 defines the controller.

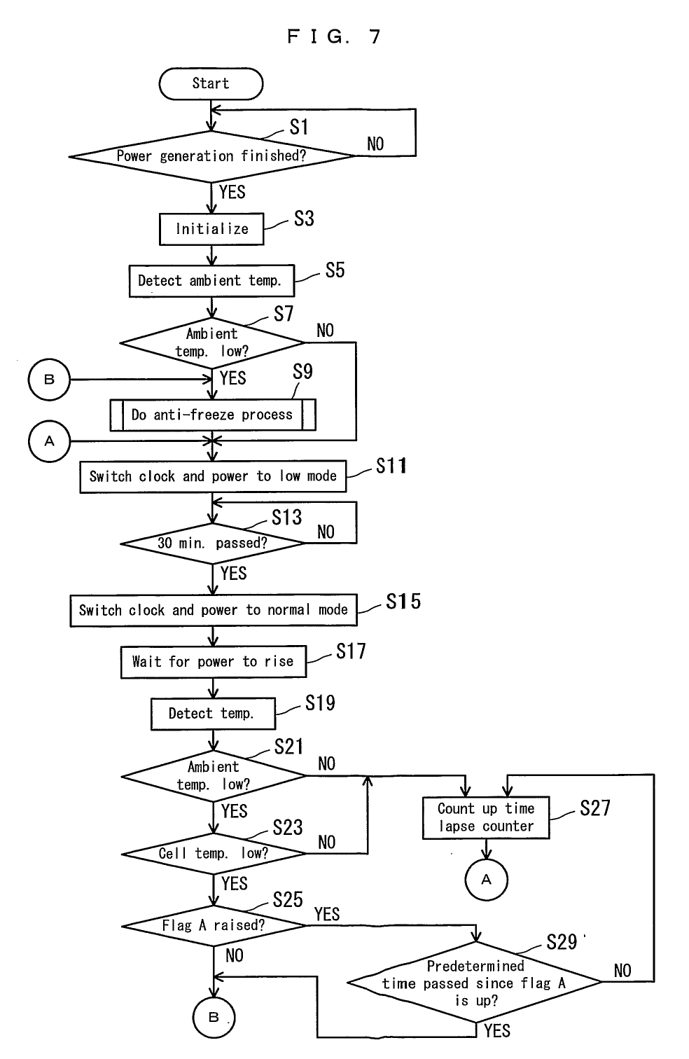

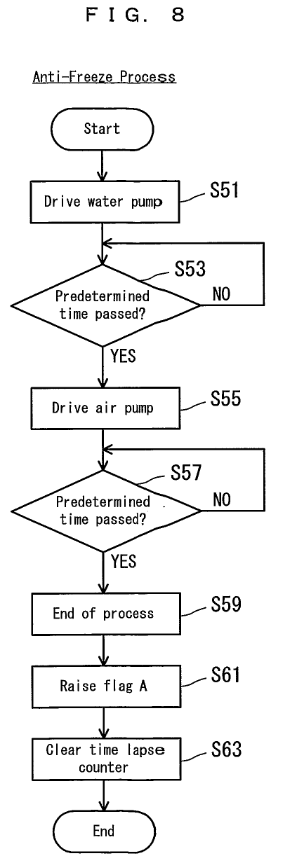

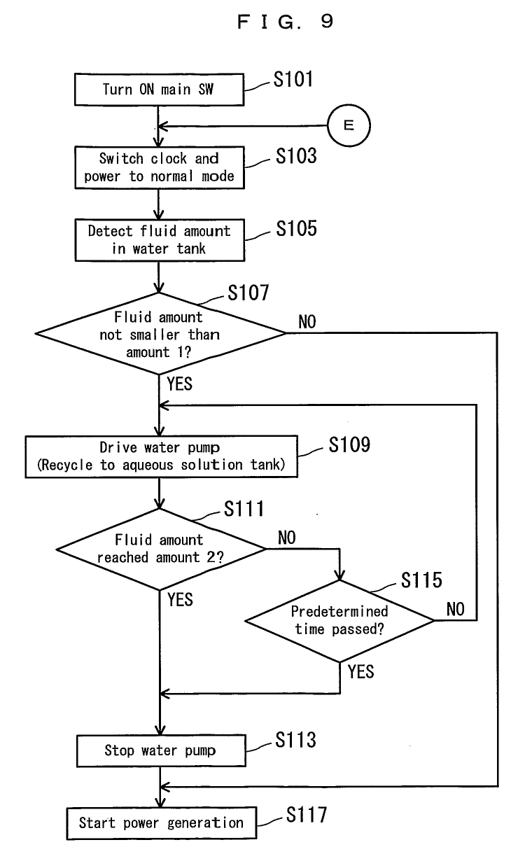

The memory 76 preferably stores various data and information including programs for performing operations shown in FIG. 7 and FIG. 8; a threshold value 1 for determining whether or not ambient temperature is low; a threshold value 2 for determining whether or not cell-stack temperature is low; a flag A which indicates whether or not an anti-freezing process has been performed (The flag is raised when the process has been made.); and a time lapse counter which indicates how much time has passed since the anti-freezing process was performed. The memory 76 also stores programs for performing operations shown in FIG. 9 through FIG. 11, first and second predetermined values which provide threshold values for the amount of fluid, and other data.

The aqueous solution tank 18 has a volume V which satisfies Equation 1: where V represents the volume of the aqueous solution tank 18; v1 represents the volume of the methanol aqueous solution S in the aqueous solution tank 18 during power generation; v2 represents the volume of fluid storable by the water tank 44; v3 represents the volume of fluid which can remain in the first channel L1; v4 represents the volume of fluid which can remain in the second channel L2; v5 represents the volume of fluid which can remain in the fuel cell stack 12; p1 represents the concentration of methanol fuel F; and p2 represents a maximum concentration of the methanol aqueous solution S.

$$V ≧ v 1 + ( v 2 + v 3 + v 4 + v 5 ) \times ( 1 + \frac{p 2}{p 1 - p 2} ) \qquad Equation 1$$

In Equation 1, the surface of the methanol aqueous solution S in the aqueous solution tank 18 during power generation is preferably set not to be higher than the fluid level sensor 22, and the volume v1 is obtainable in advance. The volume v2 is determined by the position of exhaust gas pipe 56 (or by the position of a water drain (not illustrated) if the drain is provided lower than the exhaust gas pipe 56), and is also obtainable in advance. The volumes v3, v4 and v5, as well as the concentration p1 are also obtainable in advance. The concentration of the methanol aqueous solution S is preferably set to about 2 wt % to about 10 wt %. Further, the maximum concentration p2 is also obtainable in advance.

If the aqueous solution tank 18 satisfies Equation 1, even when all of the fluid in the water tank 44, the first channel L1, the second channel L2 and the fuel cell 12 is returned to the aqueous solution tank 18, the aqueous solution tank 18 still has room to accept a volume of methanol fuel F necessary to be added for obtaining a desired concentration of the methanol aqueous solution S. Therefore, the methanol aqueous solution S will not overflow from the aqueous solution tank 18, and so there will be no external leak of the methanol aqueous solution S. This also enables to set the concentration of the methanol aqueous solution S for system startup to be higher than the concentration during power generation.

For example, when the volume of the methanol aqueous solution S in the aqueous solution tank 18 during power generation is 2 L (liters), the volume of fluid storable in the water tank 44 is 0.5 L, the volume of fluid which can remain in the first channel L1 is 0.1 L, the volume of fluid which can remain in the second channel L2 is 0.1 L, the volume of fluid which can remain in the fuel cell 12 is 0.3 L, the concentration of methanol fuel F is 50 wt %, and the maximum concentration of the methanol aqueous solution S is 10 wt %, then the volume of the aqueous solution tank 18 should be 2+(0.5+0.1+0.1+0.3)×(1 +10/(50−10))=3.25 L or greater.

Next, the water tank 44 will be described in detail.

As shown in FIG. 2 and FIG. 3, the water tank 44 is preferably made of FRP for example, is small so as to fit within a predetermined area in the vehicle frame 200, and has a lower portion that bulges more than the upper portion. The water tank 44 preferably has a volume of approximately 500 cc, for example.

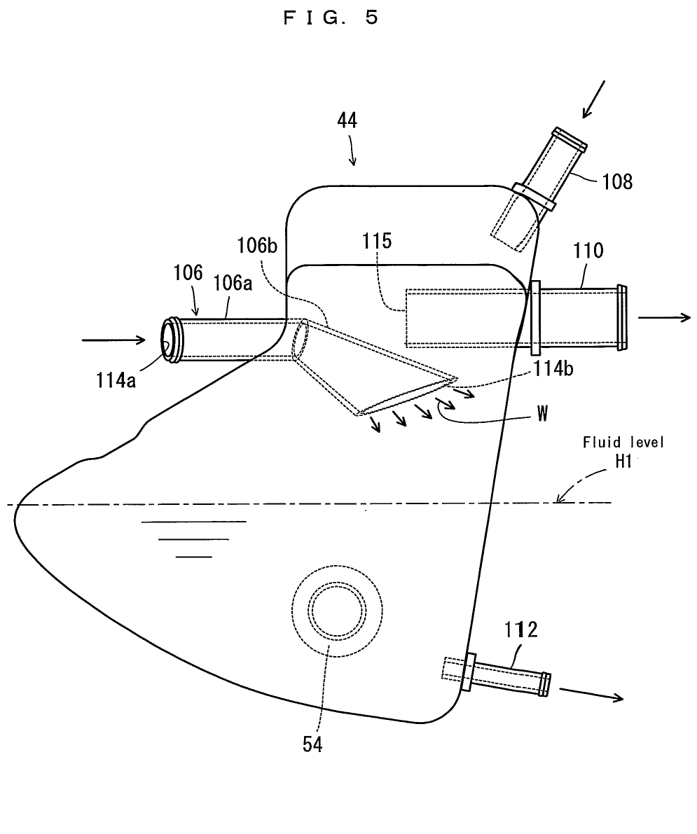

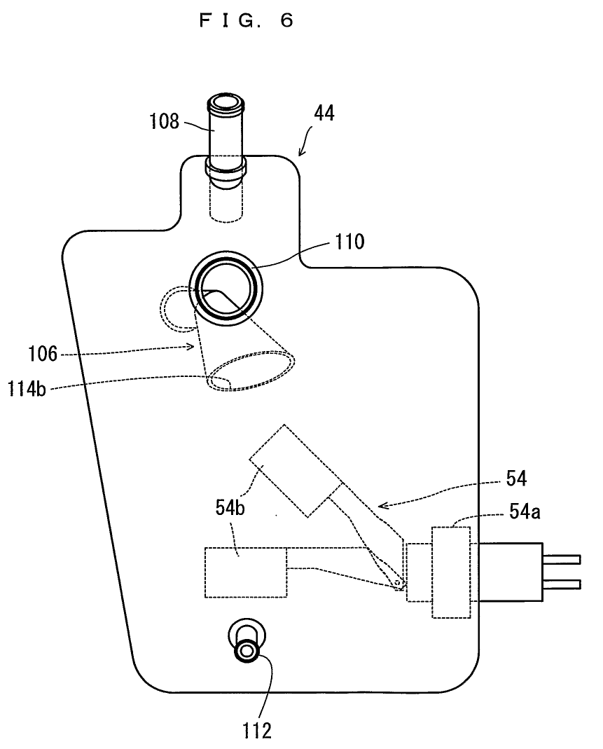

Referring to FIG. 5 and FIG. 6, intake pipes 106, 108 and discharge pipes 110, 112, each preferably made of SUS 304, for example, are inserted into the water tank 44.

The intake pipe 106 preferably has a substantially cylindrical portion 106a which goes into the water tank 44 from the front and slightly upper position of the water tank 44, and a generally funnel-shaped opening portion 106b which faces downward in the water tank 44. The opening portion 106b has an inlet port 114b whose opening is greater than an entrance 114a of the substantially cylindrical portion 106a. The substantially cylindrical portion 106a is connected with the pipe 42.

The discharge pipe 110 is preferably a substantially cylindrical pipe which goes into the water tank 44 from the back of the water tank 44, and is arranged so that its exhaust port 115 is above an opening portion 114b of the intake pipe 106 in the water tank 44. As described, the opening portion 106b and the discharge pipe 110 are arranged so that the inlet port 114b and the exhaust port 115 do not face each other in the water tank 44. The discharge pipe 110 is connected with the exhaust gas pipe 56.

The intake pipe 108 is preferably a substantially cylindrical pipe which goes into the water tank 44 from the upper surface corner of the water tank 44, and is disposed above the discharge pipe 110 in the water tank 44. The intake pipe 108 is connected with the CO₂ vent pipe 50.

The discharge pipe 112 is preferably a substantially cylindrical pipe which goes into the water tank 44 from the back and near the bottom of the water tank 44. The discharge pipe 112 is connected with the water recycling pipe 58.

Therefore, fluid and exhaust gas, etc. from the cathode 12c flows through the pipe 42 and the intake pipe 106, into the water tank 44. Carbon dioxide which comes through the aqueous solution tank 18 and the CO₂ vent pipe 50 flows into the intake pipe 108 and then to the water tank 44. Fluid in the water tank 44 goes into the discharge pipe 112 and then flows into the water recycling pipe 58. Exhaust gas which contains carbon dioxide in the water tank 44 flows through the discharge pipe 110 and the exhaust gas pipe 56 and then is released to the outside.

Below the opening portion 106b, there is disposed a fluid level sensor 54 provided by a float sensor for example for detecting the fluid level in the water tank 44. As shown in FIG. 6, the fluid level sensor 54 includes a sensor main body 54a and a float portion 54b which is attached to the sensor main body 54a. The fluid level sensor 54 is able to detect the fluid level in the water tank 44 as the float portion 54b floats up and down when the fluid level changes in the water tank 44. In other words, according to the fluid level sensor 54, the amount of fluid in the water tank 44 is detectable based on the position of the float portion 54b.

An example of operation of the fuel cell system 10 during power generation will be described.

When power generation is started, the methanol aqueous solution S which is stored in the aqueous solution tank 18 is pumped by the aqueous solution pump 26 toward the fuel cell 12. The solution is cooled as necessary by the heat exchanger 30, purified by the aqueous solution filter 32, and then supplied to the anode 12b. On the other hand, air which contains oxygen is pumped by the air pump 34 toward the fuel cell 12. The air is first purified by the air filter 38 and then supplied to the cathode 12c.

On the anode 12b in the fuel cell 12, methanol and water in the methanol aqueous solution S react electro-chemically with each other to produce carbon dioxide and hydrogen ions. The hydrogen ions move through the solid polymer film 12a to the cathode 12c, where the hydrogen ions react electro-chemically with oxygen in the air which is supplied to the cathode 12c, to produce water and electric energy.

Carbon dioxide which occurred on the anode 12b in the fuel cell 12 flows through the pipe 40, the aqueous solution tank 18, the CO₂ vent pipe 50 and the discharge pipe 108, then supplied to the water tank 44, and then it is discharged from the exhaust gas pipe 56 via the discharge pipe 110.

On the other hand, most of the water vapor occurred on the cathode 12c in the fuel cell 12 is liquefied and discharged in the form of water, with saturated water vapor being discharged in the form of gas. Part of the water vapor which was discharged from the cathode 12c is liquefied by lowering the dew point in the gas-liquid separator 48. Water (water and water vapor) and exhaust gas (including unused air), etc. discharged from the cathode 12c by the operation of the air pump 34 are supplied to the water tank 44 via the pipe 42 and the intake pipe 106. Also, water which has moved to the cathode 12c due to the water crossover is discharged from the cathode 12c and supplied to the water tank 44. Further, water and carbon dioxide which occurred at the cathode 12c due to the methanol crossover, as well as the methanol, are discharged from the cathode 12c and supplied to the water tank 44.

It should be noted here that the term water crossover is a phenomenon in which a few mols of water moves to the cathode 12c, accompanying the hydrogen ions which occur at the anode 12b and are moving to the cathode 12c. The term methanol crossover is a phenomenon in which methanol moves to the cathode 12c, accompanying the hydrogen ions which move to the cathode 12c. Most of the methanol which has moved to the cathode 12c reacts with air supplied from the air pump 34, and thereby decomposing into water and carbon dioxide.

The water, exhaust gas and so on from the cathode 12c are pumped by the air pump 34 into the water tank 44 via the inlet port 114b of the intake pipe 106 as indicated by Arrow W in FIG. 5. This causes a strong air blast in the water tank 44, so fluid which is not lower than the fluid level H1 (e.g., approximately 250 cc) indicated by a long-dash-short-dash line in FIG. 5 is blown by the air blast and discharged from the exhaust port 115 of the discharge pipe 110.

Fluid which was stored in the water tank 44 is pumped by the water pump 60 and recycled to the aqueous solution tank 18 as appropriate via the water recycling pipe 58, where it is reused as the methanol aqueous solution S. In order not to be dependent on the external supply of water, the fuel cell system 10 recycles approximately 80 % of water (water and water vapor) discharged from the cathode 12c to the aqueous solution tank 18 via the water tank 44.

The amount of fluid storable in the water tank 44 is determined by the position of the discharge pipe 110. The fluid does not come above the discharge pipe 110. If an unillustrated water drain is provided at a lower position than the discharge pipe 110, the amount of storable fluid is determined by the position of this drain.

Water vapor liquefying operation in the gas-liquid separator 48 is achieved by operating the cooling fan 46 and thereby lowering the dew point. This operation may be controlled based on an output from the fluid level sensor 54 provided in the water tank 44. Such an arrangement enables a reduction in power consumption by the cooling fan 46.

In the aqueous solution tank 18, highly concentrated methanol fuel F from the fuel tank 14 and water-containing fluid from the water tank 44 are blended, to be the methanol aqueous solution S which has an optimum concentration for power generation.

Description will now cover an example of operation of the fuel cell system 10 after power generation is finished.

Referring to FIG. 7, first the system checks if power generation is finished (Step S1). The system waits until the power generation is finished. When the power generation is finished, an initialization is performed (Step S3). In this step, the system clears the flag A which indicates whether or not the anti-freezing process has been performed, and the time lapse counter.

Next, the ambient temperature sensor 68 detects an ambient temperature (Step S5). The system checks whether or not the detected ambient temperature is low (Step S7). The check is based on whether or not the ambient temperature is not higher than the threshold value 1 (a predetermined temperature: about 4° C., for example). If the ambient temperature is lower, the anti-freezing process as shown in FIG. 8 is performed (Step S9), and the process goes to Step S11. If the ambient temperature is not lower, the anti-freezing process is not performed and the process goes to Step S11. In Step S11, the clock circuit and the power source circuit are switched to the low-consumption mode, and the system enters the low-consumption mode, where part of the fuel cell system 10 is driven in the low-consumption state. Then, the system checks if thirty minutes, for example, have passed (Step S13). If thirty minutes have already passed, the clock circuit and the power source circuit are switched to the normal mode (Step S15), and the system enters a periodic check mode. The system then waits until the power source voltage rises (Step S17), When the voltage becomes stable, the ambient temperature sensor 68 detects an ambient temperature, and the cell temperature sensor 66 detects a temperature of the fuel cell 12 (Step S19). The system checks whether or not the detected ambient temperature is low (Step S21). If the ambient temperature is low, the system checks whether or not the detected temperature of the fuel cell 12 is low (Step S23). If the temperature of the fuel cell 12 is also low, the process goes to Step S25, where the system checks whether or not the flag A is raised. If the flag A is not raised, the system determines that the anti-freezing process has never been performed since the power generation was finished, and the system is potentially frozen. Thus, the system brings the process back to Step S9, and performs the anti-freezing process.

It should be noted here that in Step S21, whether or not the ambient temperature is low is determined by checking whether or not the ambient temperature is not higher than the threshold value 1 (e.g., about 4° C.). Likewise, in Step S23, whether or not the temperature of fuel cell 12 is low is determined by checking whether or not the temperature of fuel cell 12 is not higher than the threshold value 2 (e.g., about 0° C.).

If the ambient temperature is not low or the temperature of fuel cell 12 is not low, the time lapse counter is counted up (The counter value is increased by one increment.) (Step S27). The process then goes back to Step S11, where the system is switched to the low-consumption mode. The time lapse counter is counted up every 30 minutes, for example.

If Step S25 finds that the flag A is raised, it indicates that the anti-freezing process has already been performed. So, the system checks if a predetermined amount of time has passed since the flag A was raised, i.e. since the anti-freezing process was performed last time (Step S29). The determination is based on the time lapse counter. That is, if the predetermined time is set to 2 hours, four or greater number of counts leads to the determination that the predetermined amount of time has passed. If the predetermined amount of time has not passed, the system determines that there is no probability for freezing, and brings the process back to Step S23 to count up the time lapse counter. On the other hand, if the predetermined amount of time has passed, the system determines that there is a probability for freezing, and brings the process back to Step S9 to perform the anti-freezing process.

As a summary of the above description, right after power generation is finished, the system determines that there is a probability for freezing if the ambient temperature is lower than the threshold value. Once the system enters the low-consumption mode, the system determines that there is a probability for freezing if both of the ambient temperature and the temperature of fuel cell 12 are lower than the respective threshold values and the flag A is not raised, or if both of the ambient temperature and the temperature of fuel cell 12 are lower than the respective threshold values and a predetermined amount of time has passed since the flag A was raised.

Next, reference will be made to FIG. 8 and description will be made of the anti-freezing process.

First, the water pump 60 is driven (Step S51), and when a predetermined amount of time has passed (Step S53: YES), the air pump 34 is driven (Step S55), and the system comes to a state where both of the water pump 60 and the air pump 34 are driven. When a predetermined time has passed further (Step S57: YES), the air pump 34 and the water pump 60 are stopped (Step S59). In this process, first, fluid in the water tank 44 is recycled to the aqueous solution tank 18 to some extent. Thereafter, fluid in the fuel cell 12 and the second channel L2 is collected into the water tank 44 while fluid in the water tank 44 and the first channel L1 is recycled to the aqueous solution tank 18, and eventually, all fluid in the fuel cell 12, the second channel L2, the water tank 44, and the first channel L1 is recycled to the aqueous solution tank 18. The reason why the fluid in the water tank 44 is first recycled to the aqueous solution tank 18 to some extent is to allow for the fluid from the fuel cell 12 and from the second channel L2 which flows into the water tank 44 and to avoid overflowing from the water tank 44. Then, the flag A is raised (Step S61), the time lapse counter is cleared (Step S63), and the process comes to an end.

It should be noted that in Step S19 of FIG. 7, detection of temperature of the fuel cell 12 may be replaced by detection of fluid temperature in the water tank 44, in which case Step S23 checks whether or not the fluid temperature is low (no greater than a predetermined threshold value).

According to the fuel cell system 10, after power generation is finished, fluid in the water tank 44 is all recycled to the aqueous solution tank 18 via the first channel L1, and mixed with the methanol aqueous solution S in the aqueous solution tank 18. Since this operation leaves no fluid in the water tank 44 and the first channel L1, the water tank 44 and the first channel L1 is protected from freezing, and the concentration of the methanol aqueous solution S can be adjusted appropriately. Further, the first channel L1 between the water tank 44 and the aqueous solution tank 18 can be provided by the existing water recycling pipe 58, so the system does not become complex. Further, since all the fluid in the water tank 44 is recycled to the aqueous solution tank 18, there is no likelihood that the fluid is spilled outside. The methanol aqueous solution S in the aqueous solution tank 18 has a lower solidification point than the recycled fluid, and therefore does not freeze easily.

Further, when starting power generation next time, the concentration of the methanol aqueous solution S is lower than the predetermined level. Thus, the system should simply add highly concentrated methanol fuel F at the time of power generation, and the system is not susceptible to lack of water.

Further, since the liquid in the fuel cell 12 and the second channel L2 is also recycled to the aqueous solution tank 18, freezing does not occur, either, between the fuel cell 12 and the water tank 44, making it easy to release exhaust gas and to collect fluid from the fuel cell 12.

Also, by recycling the fluid to the aqueous solution tank 18 each time when freezing is forecast, it becomes possible to deal with water crossover phenomenon and the situation in which water vapor in the second channel L2 is liquefied, making it possible to effectively prevent freezing. Further, fluid is recycled to the aqueous solution tank 18 not regularly but when freezing is forecast, after power generation is finished. Thus, it becomes possible to reduce power consumption necessary to recycle the fluid.

The anti-freezing process may be performed soon after power generation operation is finished regardless of ambient temperature, and then may be repeated again in a predetermined amount of time. Such an arrangement as described above is also effective in dealing with water crossover and liquefaction of water vapor in the second channel L2.

The present invention is particularly effective for freezing prevention on the cathode side of the fuel cell system 10.

Next, an example of operation of the fuel cell system 10 before starting power generation will be described.

Note that before starting power generation (while power generation is stopped), the system uses the low-consumption mode clock circuit 75 and the low-consumption mode power source circuit 95, and a portion of the fuel cell system 10 is actively operating in the low-consumption mode. The “low-consumption mode” is a state where a minimum number of components are driven when power generation is stopped, being ready for entering various check modes.

Referring to FIG. 9, first, when a main-switch-ON signal is entered from the input unit 98 to the CPU 72 (Step S101), the clock circuit and the power source circuit are switched to the normal mode, and the system enters the normal mode (Step S103). The system waits until the power source voltage rises. When the voltage becomes stable, the system enters a fluid amount check mode, where the fluid level sensor 54 detects the amount of fluid in the water tank 44 (Step S105).

If the amount of fluid detected in Step S105 is not smaller than a first predetermined amount (e.g., about 250 cc) (Step S107: YES), the water pump 60 is started to recycle fluid in the water tank 44 to the aqueous solution tank 18 via the water recycling pipe 58 (Step S109). Thereafter, when the amount of fluid detected by the fluid level sensor 54 has reached a second predetermined amount (e.g. 220 cc) (Step S111: YES), the water pump 60 is stopped (Step S113).

Further, even if the amount of fluid detected by the fluid level sensor 54 has not reached the second predetermined amount after Step S109 (Step S111: NO), if a predetermined time (e.g. one minute) has passed (Step S115: YES), the process moves to Step S113. As described above, by stopping the water pump 60 in a predetermined time, there are no such cases that the second predetermined amount is never detected due to a failure of the fluid level sensor 54 and power generation cannot be started. Until the predetermined time has passed (Step S115: NO), the process in Step S109 is continued.

Then after Step S113, components such as the fuel pump 20, the aqueous solution pump 26, the air pump 34, the heat-exchanger cooling fan 28, the gas-liquid separator cooling fan 46 and the water pump 60 are started, to perform power generation as described above (Step S117). If the amount of fluid detected in Step S105 is smaller than the first predetermined amount (Step S107: NO), the process also goes to Step S117.

It should be noted here that in Step S109, the water pump 60 is driven by the power from the secondary battery 102. However, the system may detect that the power from the secondary battery 102 is not enough and determine the power is not enough to drive the water pump 60. In this case, in order to avoid a shut down of the fuel cell system 10, the process transfers to power generation without driving the water pump 60. If the system is unable to transfer to power generation, then the fuel cell system 10 is manually connected with an external power source, and thereafter, processes in Step S109 and thereafter are performed.

Further, an example of operation of the fuel cell system 10 after power generation is finished will be described.

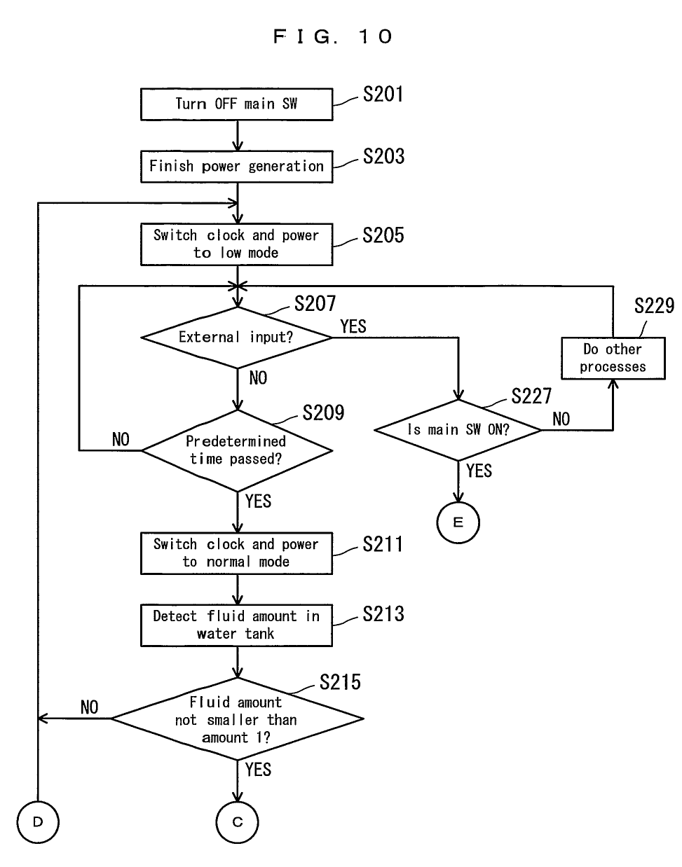

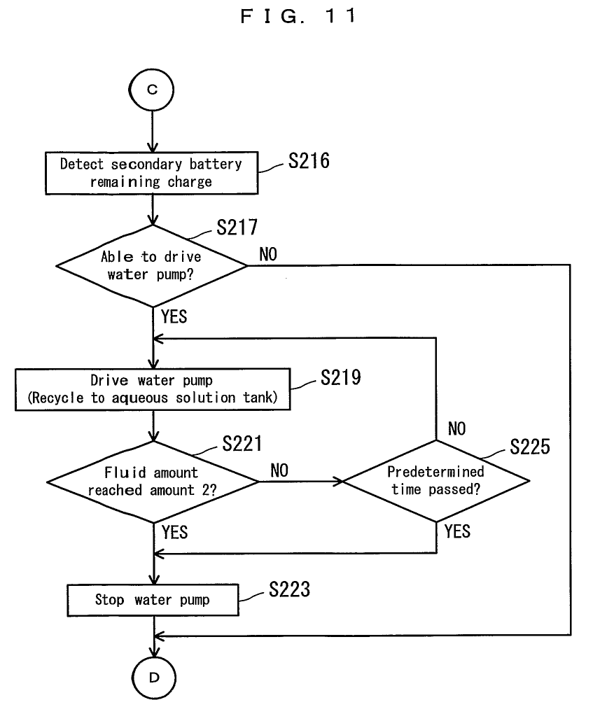

Referring to FIG. 10 and FIG. 11, first, when a main-switch-OFF signal is entered from the input unit 98 to the CPU 72 (Step S201), operations of the components are stopped in sequence, and thus the power generating operation of the fuel cell system 10 is finished (Step S203). Then, the clock circuit and the power source circuit are switched to the low-consumption mode, and the system enters the low-consumption mode (Step S205). Thereafter, if there is no more input from the input unit 98 (Step S207: NO), and a predetermined time (e.g. 30 minutes) has passed (Step S209: YES), the clock circuit and the power source circuit are switched to the normal mode, and the system enters the normal mode (Step S211). The system waits for external input until the predetermined time has passed (Step S209: NO).

After Step S211, the system waits for the power source voltage to rise, and when the voltage becomes stable, the system enters a fluid amount check mode, where the fluid level sensor 54 detects the amount of fluid in the water tank 44 (Step S213). If the amount of fluid detected in Step S213 is not smaller than a first predetermined amount (e.g. 250 cc) (Step S215: YES), the process continues to detect the remaining charge in the secondary battery 102 (Step S216). If the secondary battery 102 has enough power to drive the water pump 60 (Step S217: YES), the process starts the water pump 60, to recycle fluid in the water tank 44 to the aqueous solution tank 18 via the water recycling pipe 58 (Step S219). Thereafter, when the amount of fluid detected by he fluid level sensor 54 has reached a second predetermined amount (e.g. 220 cc) (Step S221: YES), the water pump 60 is stopped (Step S223), and the process goes back to Step S205.

The process also goes back to Step S205 if the remaining charge in the secondary battery 102 detected in Step S216 is not enough to drive the water pump 60 (Step S217: NO), or if the amount of fluid detected in Step S213 is smaller than the first predetermined amount (Step S215: NO).

Further, even if the amount of fluid detected by the fluid level sensor 54 has not reached the second predetermined amount after Step S219 (Step S221: NO), if a predetermined time (e.g. one minute) has passed (Step S225: YES), the process moves to Step S223, and back to Step S205. As described, by stopping the water pump 60 in a predetermined time, there are no such cases that the second predetermined amount is never detected due to a failure of the fluid level sensor 54 and power from the secondary battery 102 is wasted. Until the predetermined time has passed (Step S225: NO), the process in Step S219 is continued.

If Step S207 finds that there is an input from the input unit 98, and if the input is the main-switch-ON signal (Step S227: YES), the process goes to Step S103 in FIG. 9. On the other hand, if the answer in Step S227 is NO, the other process is performed (Step S229), and thereafter, the system waits for external input. In Step S229, a recharging operation to the secondary battery 102 is performed, for example. In the recharging operation to the secondary battery 102, the fuel cell system 10 is manually connected with an external power source to charge the secondary battery 102.

It should be noted here that the first predetermined amount and the second predetermined amount for the operations shown in FIG. 9 through FIG. 11 may be arbitrarily selected as long as the first predetermined amount is greater than second predetermined amount. Likewise, the time from the startup to the shutdown of water pump 60 for the operations in FIG. 9 through FIG. 11, and the time before the system enters the liquid-amount check mode in the operations shown in FIG. 10 and FIG. 11 may be discretionary.

According to the fuel cell system 10 as described above, if the amount of fluid in the water tank 44 detected before power generation is greater than a first predetermined amount, an amount of fluid in the water tank 44 which would be discharged from the exhaust port 115 by an exhaust gas associated with the operation the of air pump 34 is recycled to the aqueous solution tank 18 before the air pump 34 is driven. Likewise, each time when the amount of fluid in the water tank 44 detected at a predetermined time interval after power generation is greater than a first predetermined amount, an amount of fluid in the water tank 44 which would be discharged from the exhaust port 115 by exhaust gas associated the operation of air pump 34 is recycled to the aqueous solution tank 18. In other words, adjustment is made at a predetermined time interval, from the time a power generation is finished to the time the next power generation is started, so that the amount of fluid in the water tank 44 will not exceed the first predetermined amount. Therefore, it becomes possible to prevent discharge of fluid from the exhaust port 115 at the beginning of power generation, and to effectively reuse, without wasting, not only the fluid which is discharged from the fuel cell 12 before power generation is finished but also the fluid which oozes from the fuel cell 12 after the power generation is finished.

As described above, since it is possible to recycle the fluid in water tank 44 to the aqueous solution tank 18 before starting power generation, and to recycle the fluid in water tank 44 to the aqueous solution tank 18 at a predetermined time interval after the power generation is finished, the fluid discharged from the fuel cell 12 is reused more certainly.

In particular, since it is possible to recycle the fluid to the aqueous solution tank 18 at a predetermined time interval after the power generation is finished, the methanol aqueous solution S, which is supplied after the power generation in order to keep the solid polymer film 12a wet and then oozes from the fuel cell 12, will not reach the exhaust port 115 where it would be discharged. Therefore, methanol utilization efficiency is not decreased.

Further, since the second tank is defined by the aqueous solution tank 18, there is no need for providing a separate second tank, which enables the system to be made small.

Further, since the fluid discharged from the fuel cell 12 is used effectively without wasting, it becomes possible to improve portability of the fuel cell system 10.

It should be noted here that in the fuel cell system 10, only one of the operation shown in FIG. 9 and the operation shown in FIGS. 10 and 11 may be performed.

Further, the fuel cell system 10 is suitable for use, not only, in motorcycles but also in automobiles, marine vessels and any other transport equipment.

The present invention is also applicable to fuel cell systems which make use of a methanol-water-vapor reformer, or fuel cell systems in which hydrogen is supplied to the fuel cell. Further, the present invention is applicable to small-scale, stationary-type fuel cell systems.

The fuel to be used is not limited to methanol. The present invention is applicable to fuel cell systems which use alcohol fuel such as ethanol.

The present invention being thus far described and illustrated in detail, it is obvious that these descriptions and drawings only represent examples preferred embodiments of the present invention, and should not be interpreted as limiting the invention. The spirit and scope of the present invention is only limited by words used in the accompanying claims.

1. A fuel cell system comprising:
a fuel cell which generates electric energy by electrochemical reaction;
a first tank which holds fluid discharged from the fuel cell;
a second tank arranged to receive fluid that is stored the first tank;
a first drive device arranged to move the fluid in the first tank to the second tank; and
a controller arranged to control operation of the first drive device at a time of non-power-generation.

2. The fuel cell system according to claim 1, wherein the time of non-power-generation is a time after power generation is finished, and the second tank includes an aqueous solution tank which holds fuel aqueous solution to be supplied to the fuel cell.

3. The fuel cell system according to claim 2, further comprising a first channel which connects the first tank with the aqueous solution tank.

4. The fuel cell system according to claim 2, further comprising a second drive device arranged to move fluid in the fuel cell to the first tank,
wherein the controller is arranged to control operation of the second drive device after power generation is finished.

5. The fuel cell system according to claim 4, further comprising:
a first channel disposed so as to connect the first tank with the aqueous solution tank; and
a second channel disposed so as to connect the fuel cell with the first tank.

6. The fuel cell system according to claim 5, wherein the controller is arranged to control operation of the first drive device and the second drive device based on temperature information of the fuel cell system.

7. The fuel cell system according to claim 5, wherein the controller operates the first drive device and the second drive device again in a predetermined amount of time after operating the first drive device and the second drive device.

8. The fuel cell system according to claim 5, wherein the aqueous solution tank has a volume V which satisfies:
$$V ≧ v 1 + ( v 2 + v 3 + v 4 + v 5 ) \times ( 1 + \frac{p 2}{p 1 - p 2} )$$
where V represents the volume of the aqueous solution tank; v1 represents the volume of methanol aqueous solution in the aqueous solution tank during power generation; v2 represents the volume of fluid storable by the first tank; v3 represents the volume of fluid which can remain in the first channel; v4 represents the volume of fluid which can remain in the second channel; v5 represents the volume of fluid which can remain in the fuel cell; p1 represents a concentration of fuel; and p2 represents a maximum concentration of fuel aqueous solution.

9. The fuel cell system according to claim 1, further comprising an air pump arranged to supply the fuel cell with air necessary for generation of electric energy, and a sensor arranged to detect an amount of fluid in the first tank; wherein
the first tank includes an exhaust port;
the first drive device includes a water pump;
the controller is arranged to control operation of the water pump based on the amount of fluid in the first tank detected by the sensor, at the time of non-power-generation.

10. The fuel cell system according to claim 9, wherein the time of non-power-generation is before power generation is started, and the controller is arranged to control operation of the water pump before operating the air pump.

11. The fuel cell system according to claim 9, wherein the time of non-power-generation is after power generation is finished.

12. The fuel cell system according to claim 9, wherein the controller is arranged to control the operation of the water pump based on the volume of fluid in the first tank detected by the sensor, at a predetermined time interval after power generation is finished.

13. The fuel cell system according to claim 9, wherein the second tank includes an aqueous solution tank which holds fuel aqueous solution to be supplied to the fuel cell.

14. The fuel cell system according to claim 13, wherein the fuel cell is disposed at a lower position than the aqueous solution tank.

15. The fuel cell system according to claim 9, wherein the system is a direct methanol fuel cell system.

16. Transport equipment comprising the fuel cell system according to claim 1.

17. A control method for a fuel cell system including a fuel cell which generates electric energy by electrochemical reaction, a first tank which holds fluid discharged from the fuel cell and a second tank to which fluid in the first tank is introduced, wherein the method comprises the step of:
moving fluid in the first tank to the second tank at a time of non-power-generation.

18. The control method for a fuel cell system according to claim 17, wherein the second tank includes an aqueous solution tank which holds fuel aqueous solution to be supplied to the fuel cell, and the step of moving fluid in the first tank to the second tank is performed such that the fluid in the first tank is moved to the aqueous solution tank after power generation is finished.

19. The control method for a fuel cell system according to claim 18, wherein the fuel cell system further includes a first channel which connects the first tank with the aqueous solution tank, fluid in the first tank being moved to the aqueous solution tank via the first channel after power generation is finished.

20. The control method for a fuel cell system according to claim 18, wherein fluid in the fuel cell is moved to the aqueous solution tank via the first tank after power generation is finished.

21. The control method for a fuel cell system according to claim 19, wherein the fuel cell system further includes a second channel which connects the fuel cell with the first tank, and wherein fluid in the fuel cell and fluid in the second channel are moved to the aqueous solution tank via the first tank and the first channel after power generation is finished.

22. The control method for a fuel cell system according to claim 21, wherein the fluid is moved to the aqueous solution tank based on temperature information of the fuel cell system after power generation is finished.

23. The control method for a fuel cell system according to claim 21, wherein after power generation is finished and the fluid is moved to the aqueous solution tank, fluid is moved to the aqueous solution tank in a predetermined amount of time.

24. The control method for a fuel cell system according to claim 17, wherein the fuel cell system further includes an air pump for supplying the fuel cell with air necessary for the generation of electric energy, the first tank having an exhaust port, and fluid in the first tank is moved to the second tank if an amount of fluid in the first tank exceeds a predetermined amount, at the time of non-power-generation.

25. The control method for a fuel cell system according to claim 24, wherein fluid in the first tank is moved to the second tank prior to driving the air pump if the amount of fluid in the first tank exceeds a predetermined amount, before power generation is started.

26. The control method for a fuel cell system according to claim 24, wherein fluid in the first tank is moved to the second tank if the amount of fluid in the first tank exceeds a predetermined amount, power generation is finished.

27. The control method for a fuel cell system according to claim 24, wherein the process of moving fluid in the first tank to the second tank if the amount of fluid in the first tank exceeds a predetermined amount is performed at a predetermined time interval, after power generation is finished.

28. The control method for a fuel cell system according to claim 25, wherein fluid in the first tank is moved to the second tank if the amount of fluid in the first tank exceeds a predetermined amount, after power generation is finished.
